(19) United States
(12) Patent Application Publication
(10) Pub. No.: US 2021/0099772 A1
(43) Pub. Date: Apr. 1, 2021

(54) SYSTEM AND METHOD FOR VERIFICATION OF VIDEO INTEGRITY BASED ON BLOCKCHAIN

(71) Applicant: Rainbow Brain CO., LTD., Seoul (KR)

(72) Inventors: Wan Yeon LEE, Seoul (KR); Hyoun Ho PARK, Goyang-si (KR)

(73) Assignee: Rainbow Brain CO., LTD., Seoul (KR)

(21) Appl. No.: 17/029,916

(22) Filed: Sep. 23, 2020

(30) Foreign Application Priority Data
Sep. 24, 2019 (KR) 10-2019-0117542
Sep. 22, 2020 (KR) 10-2020-0122506

(51) Int. Cl. H04N 21/835; H04N 19/174; H04N 21/845; G06K 9/62; H04L 9/32

(52) U.S. Cl. CPC H04N 21/835; H04N 19/174; H04L 2209/38; G06K 9/6215; H04L 9/3236; H04N 21/845

(57) ABSTRACT

Disclosed herein are a blockchain-based video integrity verification system and method. The blockchain-based video integrity verification system includes: a blockchain system including a plurality of distributed nodes configured to store video integrity-related information; and a video management server including an integrity checking unit configured to perform an integrity check of an original video received from a user terminal, and a blockchain communication unit configured to transmit video integrity-related information, including information about the result of the integrity check and the hash value of the original video, to the blockchain system. The blockchain system stores the video integrity-related information transmitted from the video management server, transmits information about a storage location, at which the video integrity-related information is stored, to the video management server, and transmits a video integrity verification result based on the hash value of a query video, received from the user terminal, to the user terminal.

### CROSS-REFERENCE TO RELATED APPLICATION

This application claims the benefit of Korean Patent Applications No. 10-2019-0117542 filed on Sep. 24, 2019 and No. 10-2020-0122506 filed on Sep. 22, 2020, which are hereby incorporated by reference herein in its entirety.

### BACKGROUND

### 1. Technical Field

The present invention relates generally to a blockchain-based video integrity verification system and method, and more particularly to a system and method capable of verifying the integrity of an original video or converted video based on blockchain technology.

### 2. Description of the Related Art

Recently, with the development of the Internet and related technologies, video services, such as the services of sharing and viewing videos over the Internet, have increased significantly. However, since video editing technology has also developed, there have been an increasing number of cases in which an original video is edited or manipulated and then distributed over the Internet.

In particular, in recent years, there have been cases where deep fake videos in which faces and voices are synthesized using artificial intelligence technology are circulated via video platforms such as YouTube, thereby causing serious social problems. Since the use of software that provides such functions enables the general public to easily create and distribute fake videos, it is expected that such cases will increase gradually. With the rapid development of artificial intelligence technology, the precision of fake videos is improved, and thus technology for detecting fake videos has limitations.

Furthermore, images acquired by surveillance cameras, CCTVs, or black boxes are also used as significantly important data when a crime or traffic accident occurs. However, there are an increasing number of cases where damage is caused by images forged or falsified by cleverly editing original images using the above-described editing software that enables easy manipulation and editing.

As a conventional technology for solving this problem, Korean Patent No. 10-1890429 (published on Aug. 21, 2018) discloses an apparatus and method for verifying the integrity of a video file based on the characteristic information of a video recording device. This technology is directed to a method of finding traces of a recording device by analyzing the header area of a video file based on the fact that the header structure of a video file varies depending on each device in the process of compressing a video recorded by a video recording device and storing it in a file.

However, such conventional technologies can verify only the integrity of original video files. When original videos are uploaded over the Internet, e.g., to YouTube, most of the file formats of the original videos are converted to suit the Internet. In the case where the header structure of a video file is altered in the process of creating a converted video by reprocessing an original video (converting the original video into a file storage format suitable for distribution over the Internet) or by creating a summary (extracting important temporal portions and then combining the extracted portions in sequence), a limitation arises in that whether integrity has been damaged cannot be detected using the conventional technologies.

### SUMMARY

The present invention is intended to overcome the above-described limitations, and an object of the present invention is to provide a system and method capable of verifying the integrity of a video based on blockchain technology.

According to an aspect of the present invention, there is provided a blockchain-based video integrity verification system including: a blockchain system including a plurality of distributed nodes configured to store video integrity-related information; and a video management server including an integrity checking unit configured to perform an integrity check of an original video received from a user terminal, and a blockchain communication unit configured to transmit video integrity-related information, including information about the result of the integrity check and the hash value of the original video, to the blockchain system; wherein the blockchain system stores the video integrity-related information transmitted from the video management server, transmits information about a storage location, at which the video integrity-related information is stored, to the video management server, and transmits a video integrity verification result based on the hash value of a query video, received from the user terminal, to the user terminal.

The blockchain system may transmit a video integrity verification result, indicating that the query video is an original video the integrity of which has been verified, to the user terminal when there is present video integrity-related information corresponding to the hash value of the query video.

The video integrity verification result may include at least any one piece of information of the video integrity-related information corresponding to the hash value of the query video.

The integrity checking unit may be implemented as an application, which is a computer program; the integrity-related information transmitted from the video management server to the blockchain system may further include the hash value of the software code of the integrity checking unit; and the blockchain system may transmit an application integrity verification result, indicating that a query application has the same software code of the integrity checking unit the integrity of which has been verified, to the user terminal when there is present video integrity-related information corresponding to the hash value of the query application received from the user terminal.

The blockchain communication unit may be implemented as an application, which is a computer program; the integrity-related information transmitted from the video management server to the blockchain system may further include the hash value of the software code of the blockchain communication unit; and the blockchain system may transmit an application integrity verification result, indicating that a query application has the same software code of the blockchain communication unit the integrity of which has been verified, to the user terminal when there is present video integrity-related information corresponding to the hash value of the query application received from the user terminal.

According to another aspect of the present invention, there is provided a blockchain-based video integrity verification method that is performed by the blockchain-based video integrity verification system, the blockchain-based video integrity verification method including: a first step of performing, by a video management server, an integrity check of an original video received from a user terminal; a second step of generating, by the video management server, video integrity-related information including information about the result of the integrity check performed at the first step and the hash value of the original video, and transmitting, by the video management server, the video integrity-related information to a blockchain system; a third step of storing, by the blockchain system, the video integrity-related information transmitted from the video management server, and transmitting, by the blockchain system, information about a storage location at which the video integrity-related information is stored, to the video management server; and a fourth step of receiving, by the blockchain system, the hash value of a query video from the user terminal, and transmitting, by the blockchain system, a video integrity verification result based on the received hash value of the query video to the user terminal.

According to still another aspect of the present invention, there is provided a blockchain-based video integrity verification system including: a blockchain system including a plurality of distributed nodes configured to store video integrity-related information; and a video management server including an integrity checking unit configured to perform an integrity check of an original video, a content similarity checking unit configured to perform a content similarity check between the original video and a converted video and generate information about the result of the content similarity check, and a blockchain communication unit configured to transmit video integrity-related information, including information about the above result of the integrity check of the original video, the information about the above result of the content similarity check and the hash value of the converted video, to the blockchain system when content similarity based the result of the content similarity check is equal to or higher than a preset reference; wherein the blockchain system stores the video integrity-related information transmitted from the video management server, transmits information about a storage location, at which the video integrity-related information is stored, to the video management server, and transmits a video integrity verification result based on the hash value of a query video, received from the user terminal, to the user terminal.

The video integrity-related information may further include the hash value of the original video.

The blockchain system may transmit a video integrity verification result, indicating that the query video is a converted video the integrity of which has been verified, to the user terminal when there is present video integrity-related information corresponding to the hash value of the query video.

The video integrity verification result may include at least any one piece of information of the video integrity-related information corresponding to the hash value of the query video.

The integrity checking unit and the content similarity checking unit may be implemented as applications, respectively, which are computer programs; the integrity-related information transmitted from the video management server to the blockchain system may further include at least any one of the hash value of the software code of the integrity checking unit and the hash value of the software code of the content similarity checking unit; and the blockchain system may transmit an application integrity verification result, indicating that a query application has the same software code of the integrity checking unit or content similarity checking unit the integrity of which has been verified, to the user terminal when there is present video integrity-related information corresponding to the hash value of the query application received from the user terminal.

The blockchain communication unit may be implemented as an application, which is a computer program; the integrity-related information transmitted from the video management server to the blockchain system may further include the hash value of the software code of the blockchain communication unit; and the blockchain system may transmit an application integrity verification result, indicating that a query application has the same software code of the blockchain communication unit the integrity of which has been verified, to the user terminal when there is present video integrity-related information corresponding to the hash value of the query application received from the user terminal.

According to still another aspect of the present invention, there is provided a blockchain-based video integrity verification method that is performed by the blockchain-based video integrity verification system, the blockchain-based video integrity verification method including: a first step of acquiring, by a video management server, an original video and a converted video, and performing, by a video management server, an integrity check of the original video; a second step of performing, by the video management server, a content similarity check between the original video and the converted video, and generating, by the video management server, information about the result of the content similarity check; a third step of, when content similarity based on the result of the content similarity check performed at the second step is equal to or higher than a preset reference, generating, by the video management server, video integrity-related information including information about the result of the integrity check performed at the first step, the information about the result of the content similarity check performed at the second step and the hash value of the converted video, and transmitting, by the video management server, the video integrity-related information to a blockchain system; a fourth step of storing, by the blockchain system, the video integrity-related information transmitted from the video management server, and transmitting, by the blockchain system, information about a storage location, at which the video integrity-related information is stored, to the video management server; and a fifth step of receiving, by the blockchain system, the hash value of a query video from a user terminal, and transmitting, by the blockchain system, a video integrity verification result based on the received hash value of the query video to the user terminal.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a diagram showing the configuration of a blockchain-based video integrity verification system according to an embodiment of the present invention;

FIG. 2 is a flowchart showing a blockchain-based video integrity verification method that is performed by the blockchain-based video integrity verification system illustrated in FIG. 1;

FIG. 3 is a diagram showing the configuration of a blockchain-based video integrity verification system according to another embodiment of the present invention;

FIG. 4 is a flowchart showing a blockchain-based video integrity verification method that is performed by the blockchain-based video integrity verification system illustrated in FIG. 3;

FIG. 5 is a diagram showing an example of a blockchain system; and

FIG. 6 is a diagram showing an example of the configuration of each of the nodes of the blockchain system.

### DETAILED DESCRIPTION

Embodiments of the present invention will be described in detail below with reference to the accompanying drawings.

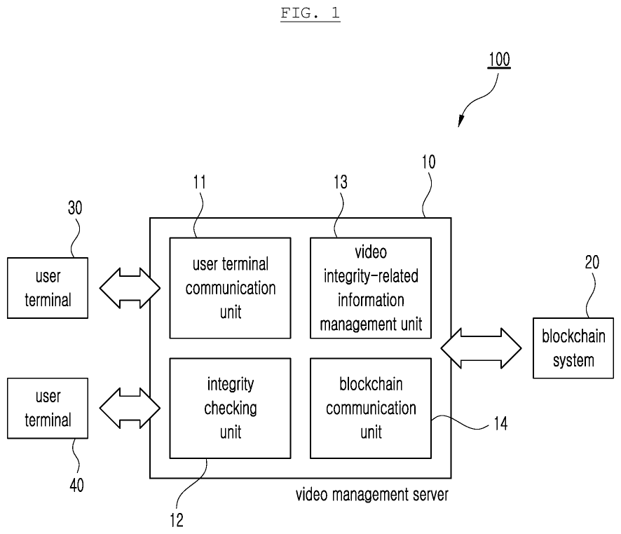

FIG. 1 is a diagram showing the configuration of a blockchain-based video integrity verification system 100 according to an embodiment of the present invention.

Referring to FIG. 1, the blockchain-based video integrity verification system 100 (hereinafter simply referred to as the “system 100”) according to the present embodiment includes a video management server 10 and a blockchain system 20 connected to each other over a network, and is connected to user terminals 30 and 40 over a network.

In this case, each of the user terminals 30 and 40 refers to a conventionally known device such as a computer or smartphone.

The video management server 10 functions to perform an integrity check of an original video received from the user terminal 30 or 40 and to transmit video integrity-related information including information about the result of the integrity check and the hash value of the original video to the blockchain system 20.

Referring to FIG. 1, the video management server 10 includes a user terminal communication unit 11, an integrity checking unit 12, a video integrity-related information management unit 13, and a blockchain communication unit 14.

The user terminal communication unit 11 is responsible for the function of transmitting and receiving data required for the practice of the present invention to and from the user terminals 30 and 40 over the network. For example, as will be described above, the user terminal communication unit 11 functions to receive an original video from the user terminal 30 or 40 and to transfer the received original video to the integrity checking unit 12. Furthermore, the user terminal communication unit 11 may transmit the original video and information about a storage location, at which video integrity-related information is stored in the blockchain system 20, to the user terminals 30 and 40, as will be described later.

The integrity checking unit 12 is responsible for the function of performing an integrity check of an original video. In this case, the integrity check refers to the process of verifying whether an original video has been altered or damaged. The integrity check may employ, e.g., a method of checking for an operating characteristic of a recording device having recorded a video in a file header.

Since the integrity checking unit 12 is not a direct target of the present invention and a known prior art unit may be used as the integrity checking unit 12, a detailed description thereof will be omitted below.

The integrity checking unit 12 may be preferably implemented in the form of an application, which is a computer program.

The video integrity-related information management unit 13 functions to generate the hash value of an original video and to generate video integrity-related information including the generated hash value of the original video and integrity check result information, which is the result of an integrity check performed by the integrity checking unit 12.

The video integrity-related information management unit 13 stores and manages the generated video integrity-related information, and transmits the generated video integrity-related information to the blockchain system 20 through the blockchain communication unit 14 so that the video integrity-related information is registered in the blockchain system 20.

The blockchain communication unit 14 functions to transmit and receive data used in the present invention while operating in conjunction with the blockchain system 20.

The blockchain communication unit 14 functions to transmit the video integrity-related information, generated by the video integrity-related information management unit 13 as described above, to the blockchain system 20 so that the video integrity-related information is stored and registered in the blockchain system 20.

Furthermore, the blockchain communication unit 14 is responsible for the function of receiving information about a storage location at which the video integrity-related information is stored in the blockchain system 20.

The blockchain communication unit 14 may be preferably implemented in the form of an application, which is a computer program.

Meanwhile, the blockchain system 20 functions to receive and store the video integrity-related information from the video management server 10, as described above.

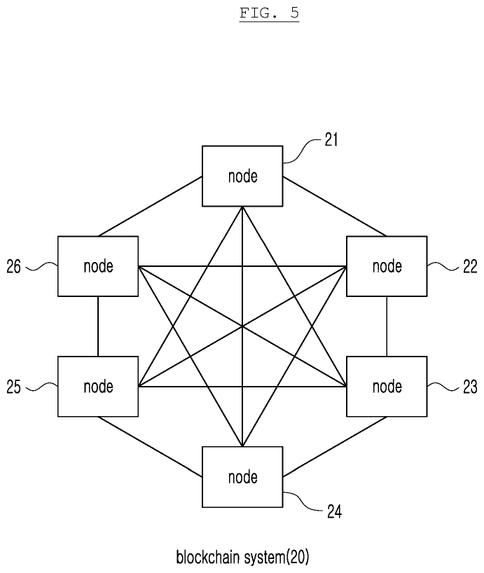

The blockchain system 20 includes a plurality of distributed nodes 21 to 26 (see FIG. 5) configured to store such video integrity-related information. These distributed nodes 21 to 26 are connected to each other over a peer to peer (P2P) network, and provides a blockchain-based video integrity verification method according to the present invention while operating in conjunction with the above-described video management server 10.

The blockchain system 20 stores the video integrity-related information transmitted from the video management server 10 and then transmits information about a storage location, at which the video integrity-related information is stored, to the video management server 10.

In this case, the information about a storage location at which the video integrity-related information is stored may be information about the address of the account of a smart contract at which the video integrity-related information is stored.

Furthermore, the blockchain system 20 receives the hash value of a query video from the user terminal 30 or 40, and transmits a video integrity verification result to the user terminal 30 or 40 based on the hash value of the query video.

In this case, the video integrity verification result refers to a signal indicating whether the query video is an original video the integrity of which has been verified.

In other words, the blockchain system 20 checks whether video integrity-related information corresponding to the hash value of the query video received from the user terminal 30 or 40 is present in the blockchain system 20, and transmits a video integrity verification result, indicating that the query video is an original video the integrity of which has been verified, to the user terminal 30 or 40 when the video integrity-related information is present in the blockchain system 20.

In this case, the video integrity verification result may include at least any one piece of information of the video integrity-related information corresponding to the hash value of the query video.

Meanwhile, the integrity-related information generated by the video integrity-related information management unit 13 of the video management server 10 may further include the hash value of the software code of the integrity checking unit 12 implemented as an application.

In this case, the user terminal 30 or 40 may transmit the hash value of the software code of the integrity checking unit 12 to the blockchain system 20 as the hash value of a query application in order to verify the integrity of the integrity checking unit 12. The blockchain system 20 may transmit an application integrity verification result, indicating that the query application has the same software code of the integrity checking unit 12 the integrity of which has been verified, to the user terminal 30 or 40 when there is present video integrity-related information corresponding to the received hash value of the query application.

Furthermore, the integrity-related information generated by the video integrity-related information management unit 13 of the video management server 10 may further include the hash value of the software code of the blockchain communication unit 14 implemented as an application.

In this case, the user terminal 30 or 40 may transmit the hash value of the software code of the blockchain communication unit 14 to the blockchain system 20 as the hash value of the query application in order to verify the integrity of the blockchain communication unit 14.

The blockchain system 20 may transmit an application integrity verification result, indicating that the query application has the same software code of the blockchain communication unit 14 the integrity of which has been verified, to the user terminal 30 or 40 when there is present video integrity-related information corresponding to the received hash value of the query application.

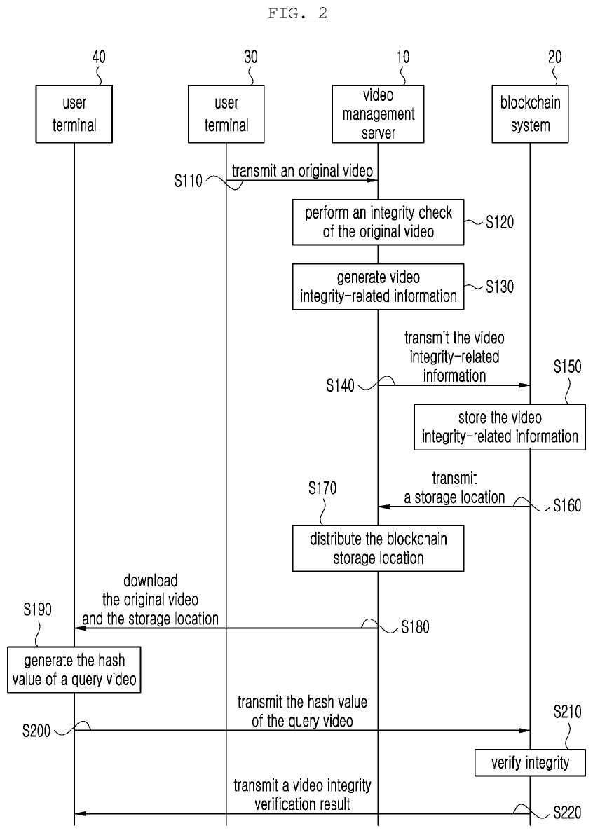

FIG. 2 is a flowchart showing a blockchain-based video integrity verification method that is performed by the blockchain-based video integrity verification system 100 illustrated in FIG. 1.

First, the user terminal 30 transmits an original video to the video management server 10 at step S110.

The video management server 10 performs an integrity check of the original video received from the user terminal 30 at step S120. This is performed by the integrity checking unit 12 implemented as an application, as described above.

Next, the video integrity-related information management unit 13 of the video management server 10 generates video integrity-related information at step S130. As described above, the video integrity-related information management unit 13 generates the hash value of the original video, and generates video integrity-related information including the generated hash value of the original video, and integrity check result information, which is the result of the integrity check performed by the integrity checking unit 12.

Next, the video management server 10 transmits the generated video integrity-related information to the blockchain system 20 through the blockchain communication unit 14 at step S140.

At step S150, the blockchain system 20 receives the video integrity-related information transmitted from the video management server 10 and stores it, thereby registering it in the blockchain system 20. This may be performed by, e.g., the smart contract of the blockchain system 20, as will be described later.

Further, the blockchain system 20 transmits information about a storage location, at which the video integrity-related information is stored within the blockchain system 20, to the video management server 10 at step S160. In this case, the information about the storage location may be information about the address of the account of the smart contract at which the video integrity-related information is stored.

The video management server 10 distributes the information about the storage location received from the blockchain system 20 through, e.g., a web page at step S170, and the user terminal 40 downloads the original video at step S180.

In this case, the user terminal 40 may also download information about an address location from the video management server 10. In this case, it is assumed that the user terminal 40 is a user terminal different from the user terminal 30 that has uploaded the original video by transmitting the original video to the video management server 10.

Next, at steps S190 and S200, the user terminal 40 generates the hash value of the original video, and transmits it to the blockchain system 20 as the hash value of a query video.

This is an integrity verification request signal adapted to verify the integrity of the query video via the blockchain system 20, and this is to request the verification of whether the downloaded original video has been forged, falsified or damaged, i.e., the verification of the integrity of the downloaded original video, from the blockchain system 20 by using the hash value of the original video, downloaded from the video management server 10 by the user of the user terminal 40, as an input.

The blockchain system 20 checks the original video for its integrity based on the hash value of the query video received from the user terminal 40 at step S210, and transmits a video integrity verification result to the user terminal 40 at step S220.

In other words, as described above, the blockchain system 20 transmits a video integrity verification result, indicating that the query video is an original video the integrity of which has been verified, to the user terminal 40 when there is present video integrity-related information corresponding to the received hash value of the query video.

This may also be performed by the smart contract of the blockchain system 20 where the video integrity-related information has been stored, as described above.

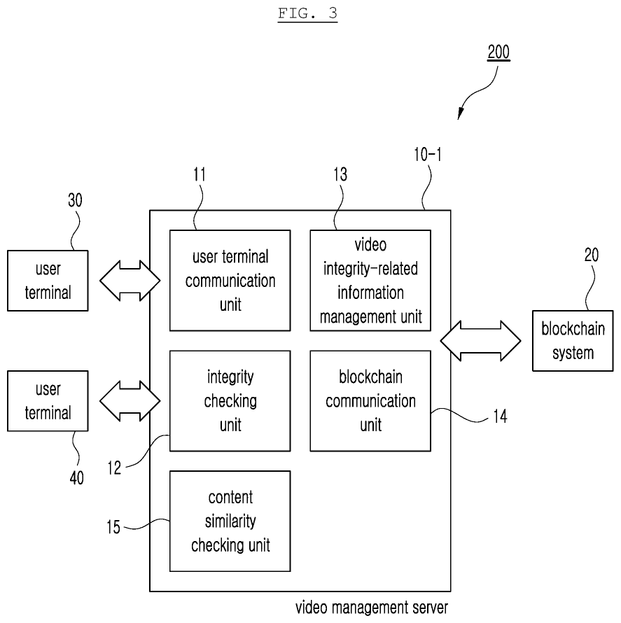

FIG. 3 is a diagram showing the configuration of a system 200 according to another embodiment of the present invention.

Although the system 200 of the embodiment shown in FIG. 3 is the same as the system 100 illustrated in FIGS. 1 and 2, they are different from each other in that a video management server 10-1 further includes a content similarity checking unit 15 and there is a difference in the content of video integrity-related information.

The content similarity checking unit 15 functions to check for the content similarity of a converted video to an original video and to generate information about the result of the content similarity check.

In this case, the original video may be transmitted from a user terminal 30 or 40. Furthermore, the converted video may be transmitted together with the original video from the user terminal 30 or 40, or may be generated by the video management server 10-1 itself. Furthermore, the converted video may be transmitted together with the original video from a separate external server.

In this case, the converted video refers to a video in which the format or content of the original video has been converted. For example, the converted video may be a video obtained by partially extracting the highlight part of the original video, deleting a part of the original video, or adding a separate video or image to the original video. Furthermore, a video obtained by adding a caption to the original video or modifying a person or object of the original video (e.g., a deep fake video) is an example of the converted video. Furthermore, a video obtained by converting the file format or encoding information of the original video may be considered to be the converted video. Moreover, a video obtained by modifying at least part of auditory information included in the original video may be viewed as an example of the converted video. In other words, any of the videos obtained by converting at least any one of the format and content of the original video may be referred to as the converted video.

Meanwhile, the information about the result of the content similarity check may include similarity information and difference information. The similarity information refers to information about the degree to which two comparison target videos, i.e., the original video and a converted video, are similar to each other in content or format, whereas the difference information refers to information about the difference between the two comparison target videos.

For example, when a converted video obtained by extracting parts of an original video and editing them is compared with the original video, the content similarity information may be provided as numerical information such as 98%. This means that the original video and the converted video are 98% identical and 2% different in content. When the converted video is a highlight summary obtained by extracting only a part of the original video, the content similarity information may be numerical information obtained by comparing the overall converted video with only the part of the original video. Furthermore, the similarity information may be the numerical information obtained by comparing only the remaining image regions excluding a partial image region such as a caption display region, or the numerical information obtained by comparing only image regions excluding auditory information.

In this case, the difference information may include, e.g., information about the frame of a converted video having a difference, time information, and information about the image capture of the corresponding frame. Furthermore, the difference information may further include the pixel information (coordinate information) of a specific portion in a per-frame image in the case where there is a difference or a difference is relatively significant in the corresponding portion.

Furthermore, the similarity information may be generated based on auditory information in addition to the above-described visual information. In the same manner, in the case where there is a difference, the difference information may include information about the frame of a converted video having the difference, time information, and information about the sound of the corresponding frame.

The content similarity checking unit 15 may be implemented as an application, and is preferably implemented in the form of a machine learning application based on artificial intelligence. However, since the content similarity checking unit 15 itself is not a direct target of the present invention and a known prior art unit may be used as the content similarity checking unit 15, a detailed description thereof will be omitted below.

Meanwhile, the video integrity-related information management unit 13 of the system 200 shown in FIG. 3 is responsible for the function of generating video integrity-related information including integrity check result information, the content similarity check result information, and the hash value of the converted video, as described in conjunction with the embodiments of FIGS. 1 and 2, when the content similarity based on the result of the content similarity check performed by the content similarity checking unit 15 is equal to or higher than a preset reference.

In this case, the video integrity-related information may further include the hash value of the original video.

The generated video integrity-related information is transmitted to the blockchain system 20 through the blockchain communication unit 14, as described in conjunction with the embodiments of FIGS. 1 and 2.

As described in conjunction with the embodiments of FIGS. 1 and 2, the blockchain system 20 stores the video integrity-related information transmitted from the video management server 10-1, transmits information about the storage location of the video integrity-related information to the video management server 10-1, receives the hash value of a query video from the user terminal 30 or 40, and then transmits a video integrity verification result to the user terminal 30 or 40 based on the hash value of the query video.

In this case, the hash value of the query video is information used to verify the integrity of the converted video, and the video integrity verification result is a signal indicating whether the query video is a converted video the integrity of which has been verified.

In other words, the blockchain system 20 checks whether video integrity-related information corresponding to the hash value of the query video received from the user terminal 30 or 40 is present in the blockchain system 20, and transmits a video integrity verification result, indicating that the query video is a converted video the integrity of which has been verified, to the user terminal 30 or 40 when the video integrity-related information is present in the blockchain system 20.

Even in this case, as described in conjunction with the embodiments of FIGS. 1 and 2, the video integrity verification result may include at least any one piece of information of the video integrity-related information corresponding to the hash value of the query video.

Meanwhile, the integrity-related information generated by the video integrity-related information management unit 13 of the video management server 10-1 may further include the hash value of the software code of the integrity checking unit 12 implemented as an application, as described above, and may further include the hash value of the software code of the content similarity checking unit 15.

In this case, the user terminal 30 or 40 may transmit at least any one of the hash value of the software code of the integrity checking unit 12 and the hash value of the software code of the similarity checking unit 15 to the blockchain system 20 as the hash value of a query application in order to verify the integrity of at least any one of the integrity checking unit 12 and the similarity checking unit 15. The blockchain system 20 may transmit an application integrity verification result, indicating that the query application has the same software code of the integrity checking unit 12 or similarity checking unit 15 the integrity of which has been verified, to the user terminal 30 or 40 when video integrity-related information corresponding to the received hash value of the query application is present.

Furthermore, even in the embodiment of FIG. 3, as described in conjunction with the embodiments of FIGS. 1 and 2, the integrity-related information generated by the video integrity-related information management unit 13 of the video management server 10-1 may further include the hash value of the software code of the blockchain communication unit 14 implemented as an application.

Since the remaining components excluding the video management server 10-1 and the blockchain system 30 are the same as those of the embodiments of FIGS. 1 and 2, detailed descriptions thereof will be omitted.

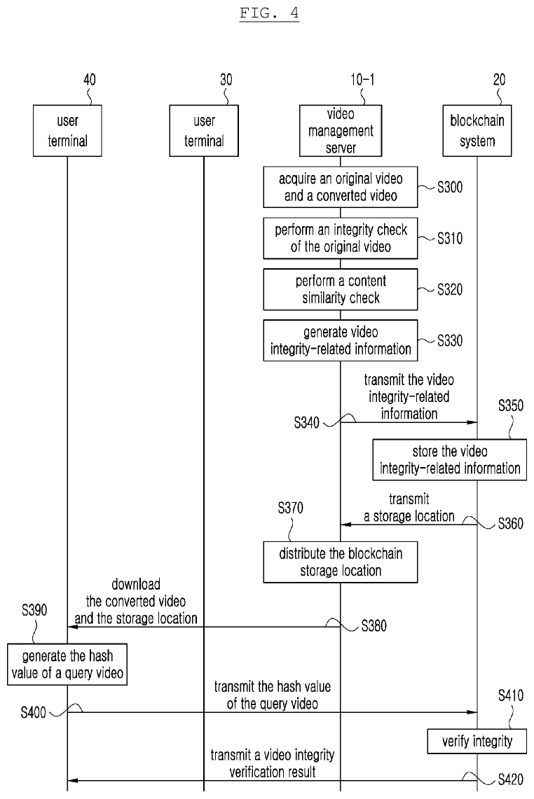

FIG. 4 is a flowchart showing a blockchain-based video integrity verification method that is performed by the system 200 illustrated in FIG. 3.

First, the video management server 10-1 acquires an original video and a converted video at step S300.

In this case, as described above, the original video may be transmitted from a user terminal 30 or 40. The converted video may be transmitted together with the original video from the user terminal 30 or 40, or may be generated by the video management server 10-1 itself. Furthermore, the converted video may be transmitted together with the original video from a separate external server.

Furthermore, the video management server 10-1 performs an integrity check of the original video received from the user terminal 30 at step S310. This is performed by the integrity checking unit 12 implemented as an application in the same manner as described in conjunction with step S120 shown in FIG. 2.

Next, at step S320, the content similarity checking unit 15 of the video management server 10-1 checks the content similarity between the original video and the converted video and generates information about the result of the content similarity check, as described above.

Furthermore, the video integrity-related information management unit 13 of the video management server 10-1 generates video integrity-related information at step S330.

As described above, the video integrity-related information management unit 13, when content similarity based on the result of the content similarity check is equal to or higher than a preset reference, generates the hash value of the converted video, and generates video integrity-related information including the generated hash value of the converted video, integrity check result information, which is the result of the integrity check performed by the integrity checking unit 12, and the content similarity check result information.

In this case, the video integrity-related information may further include the hash value of the original video.

Next, the video management server 10-1 transmits the generated video integrity-related information to the blockchain system 20 through the blockchain communication unit 14 at step S340.

At step S350, the blockchain system 20 receives the video integrity-related information transmitted from the video management server 10-1 and stores it, thereby registering it in the blockchain system 20. This may be performed by, e.g., the smart contract of the blockchain system 20, as will be described later.

Furthermore, the blockchain system 20 transmits information about a storage location, at which the video integrity-related information is stored within the blockchain system 20, to the video management server 10-1 at step S360. In this case, the information about the storage location may be information about the address of the account of the smart contract at which the video integrity-related information is stored.

The video management server 10-1 distributes the information about the storage location received from the blockchain system 20 through, e.g., a web page at step S370, and the user terminal 40 downloads the converted video at step S380.

In this case, the user terminal 40 may also download information about an address location from the video management server 10-1. In this case, it is assumed that the user terminal 40 is a user terminal different from the user terminal 30 that has uploaded the converted video by transmitting the converted video to the video management server 10.

Next, at steps S390 and S400, the user terminal 40 generates the hash value of the converted video, and transmits it to the blockchain system 20 as the hash value of a query video.

This is an integrity verification request signal adapted to verify the integrity of the converted video via the blockchain system 20, and is to request the verification whether the downloaded converted video has been forged, falsified or damaged by using the hash value of the converted video downloaded from the video management server 10-1 by the user of the user terminal 40 as an input, i.e., the verification of the integrity of the downloaded converted video, from the blockchain system 20.

The blockchain system 20 checks the converted video for its integrity based on the hash value of the query video received from the user terminal 40 at step S410, and transmits a video integrity verification result to the user terminal 40 at step S420.

In other words, the blockchain system 20 transmits a video integrity verification result, indicating that the query video is a converted video the integrity of which has been verified, to the user terminal 40 when there is present video integrity-related information corresponding to the received hash value of the query video.

This may also be performed by the smart contract of the blockchain system 20 where the video integrity-related information has been stored, as described above.

According to the present invention described above, the application configured to perform the function of checking for the integrity of an original video and the application configured to perform the function of checking for the content similarity between an original video and a converted video are provided in the video management server 10, and the hash values of the applications of the video management server 10 including the above applications are registered in the blockchain system 20. Accordingly, a user may permanently verify the accuracy of the operation processes of the application configured to perform the function of checking for the integrity of an original video and the application configured to perform the function of checking for the content similarity between an original video and a converted video.

Furthermore, after the integrity of an original video or converted video has been verified once, the result of an integrity check for the original video or converted video permanently stored in the blockchain system 20 may be checked using only the hash value of the original video or converted video.

Furthermore, after the integrity of a converted video file has been verified once, the result of an integrity check for a converted video permanently stored in the blockchain system 20 may be checked using only the hash value of the converted video file.

Furthermore, an integrity check for an original video and a content similarity check for the original video and a converted video may be simultaneously performed, thereby being utilized for the verification of the content integrity of the converted video.

Furthermore, for a twice-processed, secondary-converted video, a content integrity check for a primary-converted video and a content similarity check for the primary-converted video and a secondary-converted video may be simultaneously performed, thereby being utilized for the verification of the content integrity of the secondary-converted video.

Furthermore, the difference between an original video and a converted video is stored and registered in the blockchain system 20, and thus, the difference between the original video and the converted video may be accurately identified with reliability.

The video integrity verification method using the blockchain system 20 based on the cooperative operation among the above-described blockchain system 20, video management server 10, and user terminal 30 or 40 is performed by the smart contract function of the blockchain system 20.

The operation of the smart contract and the configuration of the blockchain system 20 for performing the operation will be described below.

FIG. 5 is a diagram showing an example of the blockchain system 20.

As shown in FIG. 5, the blockchain system 20 includes the plurality of distributed nodes 21 to 26, and the plurality of nodes 21 to 26 constitutes a network directly connected to each other by a peer to peer (P2P) communication protocol.

In this case, each of the plurality of nodes 21 to 26 may physically be a device such as a computer, a tablet personal computer (PC), or a smartphone, and may store a ledger shared with the other nodes by a predetermined consensus algorithm. The ledger may be configured in the form of a chain in which a plurality of blocks is connected.

For example, as known in conventional blockchain platforms such as Bitcoin or Ethereum, each of the blocks that constitute a blockchain is composed of a block body in which transaction detail information obtained via the blockchain system 20 is stored, and a block header. Such blocks may be created and included in a blockchain through so-called Proof of Work (PoW) by so-called miner nodes.

Meanwhile, the blockchain system 20 according to the present invention includes a so-called “smart contract” function, and provides the above-described video integrity verification method via the smart contract function.

A smart contract is known by the Ethereum blockchain platform. In conventional blockchain platforms such as Bitcoin, the blocks that constitute a blockchain store only simple transaction details. In contrast, a “smart contract” composed of code by programming refers to an application that is stored in the blockchain system 20, is executed on the nodes 21 to 26 constituting the blockchain system 20, and allows transaction details based on the results of the execution to be incorporated into a block.

In order to execute such a smart contract, as an embodiment, each of the nodes 21 to 26 constituting the blockchain system 20 may have a virtual machine for executing the smart contract.

Since the concepts of such a block, a blockchain, and a blockchain system 20 themselves are known in prior art and the configuration of the blockchain system 20 itself is not a direct target of the present invention, a detailed description thereof will be omitted below.

Meanwhile, the blockchain system 20 according to the present invention may be configured in the form of a public blockchain open to everyone, such as Ethereum or the like, or may be configured in the form of a closed private blockchain consisting of only specific users.

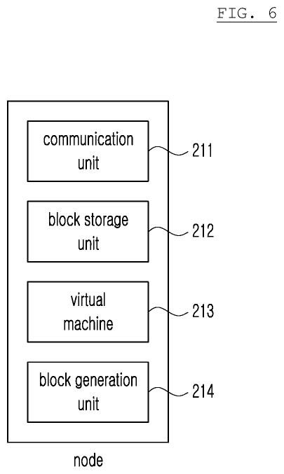

FIG. 6 is a diagram showing an example of the configuration of each of the nodes 21 to 26 of the blockchain system 20.

Referring to FIG. 6, each of the nodes 21 to 26 may include a communication unit 211, a block storage unit 212, a virtual machine 213, and a block generation unit 214.

The communication unit 211 is a means for performing the function of performing P2P connection with the nodes 21 to 26 constituting the blockchain system 20 and communication with the video management server 10 and the user terminals 30 and 40. The block storage unit 212 is responsible for the function of storing the blocks constituting the blockchain, as described above.

A ledger adapted to store transaction details and information is stored in the block storage unit 212 according to the present invention, and is shared among the nodes 21 to 26 via the P2P connection.

The virtual machine 213 is a means for executing a smart contract. As described above, the blockchain system 20 according to the present invention functions to store a smart contract adapted to receive video integrity-related information, store the video integrity-related information and transmit the video integrity-related information to the video management server 10 and a smart contract adapted to receive the hash value of an original video or converted video, i.e., a query video, from the user terminal 30 or 40, check whether hash values are identical to each other based on the hash value of the original video or converted video, and transmit a video integrity verification result to the user terminal 30 or 40 as the result of the checking and also functions to execute the smart contracts, thereby providing the above-described video integrity verification service.

As an embodiment, the smart contracts adapted to perform the above functions are deployed to the blockchain system 20 by the video management server 10 and shared by and stored in the block storage units 212 of the nodes 21 to 26, as described above.

Furthermore, when the hash value of an original video or converted video is received from the video management server 10, the smart contract is executed, and an integrity verification result is transmitted to the user terminal 30 or 40 when video integrity-related information corresponding to the corresponding hash value is present.

In other words, the video management server 10 transmits a transaction including the hash value of the original video or converted video to the blockchain system 20, and the blockchain system executes the corresponding smart contract in response to the transaction, checks whether video integrity-related information corresponding to the received hash value is present as described above, and transmits a video integrity verification result to the user terminal 30 or 40 based on the result of the checking.

Meanwhile, the block generation unit 214 is a means for generating a new block, and performs a function corresponding to mining in prior art blockchain technology. Since this is not a direct target of the present invention and a known prior art unit may be used as the block generation unit 214, a detailed description thereof will be omitted below.

Meanwhile, although the nodes 21 to 26 constituting parts of the blockchain system 20 have been described as functionally operating only for the blockchain system 20 and being present separately from the video management server 10 and the user terminals 30 and 40, this is based on functional division. It is obvious that the video management server 10 and the user terminals 30 and 40 may also be some of the nodes 21 to 26 constituting the blockchain system 20.

Since the configuration of the nodes 21 to 26 is also known in prior art and is not a direct target of the present invention, other detailed descriptions thereof will be omitted below.

According to the present invention, there are provided the system and method capable of verifying the integrity of a video based on blockchain technology.

Furthermore, according to the present invention, the integrity of the application having performed an integrity check of a video and the integrity of the application having performed a content similarity check may also be verified, and thus an advantage arises in that the reliability of the verification of the integrity of the video may be further increased.

Although the preferred embodiments according to the present invention have been described above, the scope of the present invention is not limited to these embodiments. It is obvious that various modifications and alterations made by those having ordinary skill in the art to which the present invention pertains within the scope of the present invention defined by the appended claims also fall within the scope of the present invention.

1. A blockchain-based video integrity verification system comprising:
a blockchain system including a plurality of distributed nodes configured to store video integrity-related information; and
a video management server including an integrity checking unit configured to perform an integrity check of an original video received from a user terminal, and a blockchain communication unit configured to transmit video integrity-related information, including information about a result of the integrity check and a hash value of the original video, to the blockchain system;
wherein the blockchain system stores the video integrity-related information transmitted from the video management server, transmits information about a storage location, at which the video integrity-related information is stored, to the video management server, and transmits a video integrity verification result based on a hash value of a query video, received from the user terminal, to the user terminal.

2. The blockchain-based video integrity verification system of claim 1, wherein the blockchain system transmits a video integrity verification result, indicating that the query video is an original video whose integrity has been verified, to the user terminal when there is present video integrity-related information corresponding to the hash value of the query video.

3. The blockchain-based video integrity verification system of claim 2, wherein the video integrity verification result includes at least any one piece of information of the video integrity-related information corresponding to the hash value of the query video.

4. The blockchain-based video integrity verification system of claim 1, wherein:
the integrity checking unit is implemented as an application, which is a computer program;
the integrity-related information transmitted from the video management server to the blockchain system further includes a hash value of software code of the integrity checking unit; and
the blockchain system transmits an application integrity verification result, indicating that a query application has the same software code of the integrity checking unit whose integrity has been verified, to the user terminal when there is present video integrity-related information corresponding to a hash value of the query application received from the user terminal.

5. The blockchain-based video integrity verification system of claim 4, wherein:
the blockchain communication unit is implemented as an application, which is a computer program;
the integrity-related information transmitted from the video management server to the blockchain system further includes a hash value of software code of the blockchain communication unit; and
the blockchain system transmits an application integrity verification result, indicating that a query application has the same software code of the blockchain communication unit whose integrity has been verified, to the user terminal when there is present video integrity-related information corresponding to a hash value of the query application received from the user terminal.

6. A blockchain-based video integrity verification method that is performed by the blockchain-based video integrity verification system of claim 1, the blockchain-based video integrity verification method comprising:
a first step of performing, by a video management server, an integrity check of an original video received from a user terminal;
a second step of generating, by the video management server, video integrity-related information including information about a result of the integrity check performed at the first step and a hash value of the original video, and transmitting, by the video management server, the video integrity-related information to a blockchain system;
a third step of storing, by the blockchain system, the video integrity-related information transmitted from the video management server, and transmitting, by the blockchain system, information about a storage location at which the video integrity-related information is stored, to the video management server; and
a fourth step of receiving, by the blockchain system, a hash value of a query video from the user terminal, and transmitting, by the blockchain system, a video integrity verification result based on the received hash value of the query video to the user terminal.

7. A blockchain-based video integrity verification system comprising:
a blockchain system including a plurality of distributed nodes configured to store video integrity-related information; and
a video management server including an integrity checking unit configured to perform an integrity check of an original video, a content similarity checking unit configured to perform a content similarity check between the original video and a converted video and generate information about a result of the content similarity check, and a blockchain communication unit configured to transmit video integrity-related information, including information about the above result of the integrity check of the original video, the information about the above result of the content similarity check and a hash value of the converted video, to the blockchain system when content similarity based the result of the content similarity check is equal to or higher than a preset reference;
wherein the blockchain system stores the video integrity-related information transmitted from the video management server, transmits information about a storage location, at which the video integrity-related information is stored, to the video management server, and transmits a video integrity verification result based on a hash value of a query video, received from the user terminal, to the user terminal.

8. The blockchain-based video integrity verification system of claim 7, wherein the video integrity-related information further includes a hash value of the original video.

9. The blockchain-based video integrity verification system of claim 7, wherein the blockchain system transmits a video integrity verification result, indicating that the query video is a converted video whose integrity has been verified, to the user terminal when there is present video integrity-related information corresponding to the hash value of the query video.

10. The blockchain-based video integrity verification system of claim 9, wherein the video integrity verification result includes at least any one piece of information of the video integrity-related information corresponding to the hash value of the query video.

11. The blockchain-based video integrity verification system of claim 7, wherein:
the integrity checking unit and the content similarity checking unit are implemented as applications, respectively, which are computer programs;
the integrity-related information transmitted from the video management server to the blockchain system further includes at least any one of a hash value of software code of the integrity checking unit and a hash value of software code of the content similarity checking unit; and
the blockchain system transmits an application integrity verification result, indicating that a query application has the same software code of the integrity checking unit or content similarity checking unit whose integrity has been verified, to the user terminal when there is present video integrity-related information corresponding to a hash value of the query application received from the user terminal.

12. The blockchain-based video integrity verification system of claim 11, wherein:
the blockchain communication unit is implemented as an application, which is a computer program;
the integrity-related information transmitted from the video management server to the blockchain system further includes a hash value of software code of the blockchain communication unit; and
the blockchain system transmits an application integrity verification result, indicating that a query application has the same software code of the blockchain communication unit whose integrity has been verified, to the user terminal when there is present video integrity-related information corresponding to a hash value of the query application received from the user terminal.

13. A blockchain-based video integrity verification method that is performed by the blockchain-based video integrity verification system of a claim 7, the blockchain-based video integrity verification method comprising:
a first step of acquiring, by a video management server, an original video and a converted video, and performing, by a video management server, an integrity check of the original video;
a second step of performing, by the video management server, a content similarity check between the original video and the converted video, and generating, by the video management server, information about a result of the content similarity check;
a third step of, when content similarity based on the result of the content similarity check performed at the second step is equal to or higher than a preset reference, generating, by the video management server, video integrity-related information including information about a result of the integrity check performed at the first step, the information about the result of the content similarity check performed at the second step and a hash value of the converted video, and transmitting, by the video management server, the video integrity-related information to a blockchain system;
a fourth step of storing, by the blockchain system, the video integrity-related information transmitted from the video management server, and transmitting, by the blockchain system, information about a storage location, at which the video integrity-related information is stored, to the video management server; and
a fifth step of receiving, by the blockchain system, a hash value of a query video from a user terminal, and transmitting, by the blockchain system, a video integrity verification result based on the received hash value of the query video to the user terminal.
